(19) United States
(12) Patent Application Publication
(10) Pub. No.: US 2009/0189730 A1
(43) Pub. Date: Jul. 30, 2009

(54) LOW TEMPERATURE FUSE

(75) Inventors: Seibang Oh, Elk Grove Village, IL (US); Alexander Conrad, Braunfels (DE); Juergen Scheele, Wildeshausen (DE)

Correspondence Address: K&L Gates LLP, P.O. BOX 1135, CHICAGO, IL, 60690, US

(73) Assignee: LITTELFUSE, INC., Des Plaines, IL (US)

(21) Appl. No.: 12/362,913

(22) Filed: Jan. 30, 2009

Related U.S. Application Data
(60) Provisional application No. 61/024,791, filed on Jan. 30, 2008.

(51) Int. Cl. H01H 85/04

(52) U.S. Cl. 337/186; 337/290

(57) ABSTRACT

A fuse is disclosed, the fuse made of a first metal, such as copper, and having a notched portion with an alloying element, such as tin, deposited in the notch. The alloying element helps to lower the voltage drop across the notch, allowing the fuse to generate less heat during operation without affecting its ability to protect a circuit to which it is connected. The fuse may also include a housing and terminals to connect into a circuit.

### CLAIM TO PRIORITY

The present disclosure claims priority to, and the benefit under 35 U.S.C. §119 of, U.S. Prov. Appl. 61/024,791, filed on Jan. 30, 2008, and entitled “Low Temperature Fuse,” which is hereby incorporated by reference in its entirety.

### BACKGROUND

The present disclosure relates generally to circuit protection. More particularly, the present disclosure relates to fuses, such as relatively high current fuses.

A difference exists between a “fuse” and a “protector.” A fuse protects against short circuit events and overloads. Protectors are considered to only provide short circuit protection. It is desirable that the protectors, which typically operate at higher current ratings, also provide short circuit protection. To do so, the protectors need to run cooler.

It is also desirable for a fuse to run cooler, which allows less expensive plastics for the fuse housing and surrounding structures, having lower melting temperatures, to be used.

It is further desirable for a fuse to operate with a lower voltage drop, saving power and further reducing temperature.

It is additionally desirable for a fuse to respond to a wider range of overcurrent conditions.

For certain fuses, vibration and mounting become an issue. Both place mechanical stress on the fuse, which can cause the fuse element to rupture.

The fuse of the present disclosure attempts to address the above issues.

### SUMMARY

The present disclosure includes a fuse having a fuse element, which allows the fuse to run cooler and provides a lower voltage drop than in known like fuses. A gap is formed in the fuse element and is filled with a low temperature material, such as tin or tin-alloy. This structure is different than merely applying a tin spot on the top of the fuse element as has been done previously. The tin actually forms or becomes part of the fuse element. The high amount of the low temperature material allows the element to run cooler, which provides a number of benefits. One of the benefits is that the housing of the fuse can be made of a lower melting temperature and thus a lower cost insulating plastic. Also, the customer's fuse box in which the fuse is mounted can be made of a lower grade and more inexpensive material. Alternatively, the same fuse box can be used and fitted with more components.

The tin infill or inlay in an embodiment consumes at least sixty percent of the height of the base metal or copper. In one embodiment, about eighty percent or greater of the height is removed and filled with the tin insert. This allows certain types of fuses having higher ratings, for example, above about 350 amperes, to be used for both short circuit and low overload protection. The present design opens the possibility of increasing the thermal mass of the element, outputting a higher I²t (current-time rating) output at a lower rated current than in a similar known fuse. This enables the fuses to be used in areas previously unobtainable, such as fuses for certain starters, batteries and automotive power cables. The resulting fuse also responds to a wider range of overcurrent conditions.

The metal portion of the fuse can be fixed to the insulative housing at locations very close to the fuse element. Such connection allows the element and thus the resulting fuse to better withstand mechanical stress due to fuse mounting and operational vibrations.

In one embodiment, the fuse opens below about 300° C., which is a significant improvement over similar fuses that have opened at about 550° C.

In one embodiment, the gap in the base or copper material also includes a hole or aperture. The hole or aperture holds the tin or low melting temperature infill in place using the surface tension of the low melting temperature metal. When the fuse is placed under load, the tin spot becomes warm and soft. The hole helps to ensure that the tin infill does not slide off the base material. The tin flows through the hole and can flow onto the outer surface of the base copper, which tends to lock the tin spot in place.

In one embodiment, the fuse includes a housing and a conductive portion. The conductive portion is covered by the housing and has first and second terminals. The terminals extend from a fuse element of the conductive portion. The fuse element comprises a conductive metal and defines a gap filled with a low melting temperature metal.

In an embodiment, the gap in cross-section removes at least about sixty percent of the conductive metal, i.e., about sixty percent of the cross section is removed.

In an embodiment, the gap is completely filled with the low melting temperature metal.

In an embodiment, the conductive metal is one of copper and a copper alloy.

In an embodiment, the low melting temperature metal is one of a tin and a tin alloy.

In yet another embodiment, the housing is made of a material selected from the group consisting of: nylon, polyphthalamide, phenolic and polyethylene terephthalate.

In an embodiment, the housing is fixed to the conductive portion at least one point located directly adjacent to the fuse element portion.

In an embodiment, the housing is fixed to the conductive portion at least one point located directly adjacent to the gap.

In still another embodiment, the conductive or base metal forms a bottom surface of the gap and includes an aperture through the bottom surface of the gap.

In an embodiment, the low melting temperature metal fills the aperture.

In an embodiment, the low melting temperature metal extends onto a surface of the conductive or base metal opposing the bottom surface of the gap.

In another embodiment, the fuse element includes a housing and a conductive portion, in which the conductive portion is covered by the housing and includes first and second terminals. The terminals extend from a fuse element portion of the conductive portion. The fuse element portion includes an infilled low temperature metal which is configured to: (i) lower an operating temperature of the conductive portion, and (ii) lower a voltage drop across the conductive portion as compared to a fuse element portion of the conductive portion not having the infilled, low temperature metal.

In an embodiment, the fuse element portion includes a base metal defining a gap and the low temperature metal is infilled into the gap.

In an embodiment, the gap is formed by skiving or stamping.

In still a further embodiment, the base metal forms a bottom surface of the gap and includes an aperture through the bottom surface. The low temperature metal fills the aperture.

In an embodiment, the conductive portion includes a base metal that is at least partially copper. The low temperature metal is at least partially tin.

In yet another embodiment, the fuse includes first and second outermost spaced terminal portions, first and second arms and a fuse link-forming intermediate portion. The first and second arms extend from the respective first and second terminal portions. The fuse link-forming intermediate portion is between the first and second arms. The fuse link-forming intermediate portion includes a main copper portion, a notched portion, and a tin portion. The main copper portion has a first thickness and the notched portion is disposed in the main copper portion and has a second thickness. The second thickness is less than about forty percent of the first thickness. The tin portion is disposed in the notched portion.

In an embodiment, a housing is disposed around a fuse element, the first and second arms, and at least portions of the first and second terminal portions.

In an embodiment, securing members are disposed on the first and second arms directly adjacent to the fuse link-forming portion.

In another embodiment, the fuse maintains an operating temperature of less than about 300° C.

It is accordingly an advantage of the present disclosure to provide a fuse that affords short circuit and low overload protection at higher current ratings.

It is another advantage of the present disclosure to provide a fuse that runs cooler, such that the fuse can have a housing made of a lower melting temperature and thus lower cost polymer.

It is a further advantage of the present disclosure to provide a fuse that operates with a relatively low voltage drop, conserving power.

It is yet another advantage of the present disclosure to provide a fuse that better withstands vibration and mechanical stress experienced when mounted.

Additional features and advantages are described herein, and will be apparent from, the following Detailed Description and the figures.

### BRIEF DESCRIPTION OF THE FIGURES

FIG. 1 is a perspective view of one embodiment of the fuse of the present disclosure.

FIG. 2 is a schematic view of one embodiment of a metal portion of the fuse of the present disclosure.

FIGS. 3A to 3C illustrate one embodiment for forming the fuse element of the present disclosure.

FIG. 4 is an elevation, sectioned view of one embodiment of the fuse element of the present disclosure.

FIG. 5 is an alternative embodiment of the fuse of the present disclosure.

FIG. 6 is a graph illustrating the improved voltage drop characteristics of the fuse of the present disclosure.

FIG. 7 is a graph illustrating the low overload operation of the fuse of the present disclosure.

### DETAILED DESCRIPTION

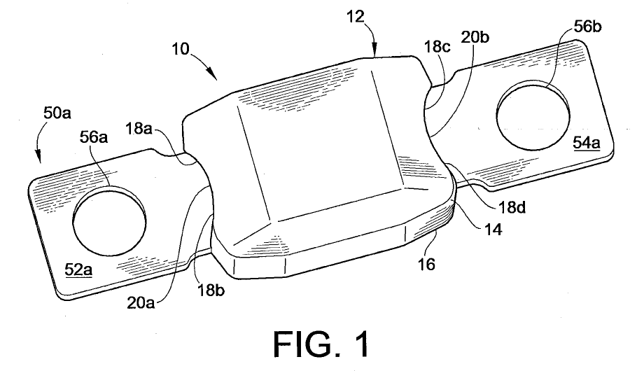

Referring now to the drawings and in particular to FIG. 1, fuse 10 illustrates one embodiment of the low operating temperature, low voltage drop fuse of the present disclosure. The fuse element and resulting fuse can be used in various types of automotive fuses, such as ATO®, MINI®, MAXI™, JCASE™, MIDI®, CablePro®, low profile MINI® or low profile JCASE™ fuses provided by the assignee of the present disclosure.

Fuse 10 includes a housing 12 and a metal or conductive portion 50a. Due to the low operating temperature of conductive portion 50a and the ability to fix housing 12 to conductive portion 50a close to the fuse element portion of conductive portion 50a, housing 12 can be made of a relatively inexpensive and lower melting temperature plastic. Housing 12 in one embodiment is made of first and second halves 14 and 16, which are fixed together at staking or riveting positions 18a to 18d. Stake or riveting positions 18a to 18d, which can support cold staking, hot staking or riveting, also fix metal portion 50a within housing 10. To facilitate the heat staking of insulative housing 12, flat portions 20a and 20b are provided to overlay the staking holes (shown below) of conductive portion 50a.

Another advantage of the fuse of the present disclosure is that the low opening temperature of the fuse element of conductive portion 50a allows attachment positions 18a to 18d (or at least some of them) to be made or placed closer to the fuse element as shown below. Such placement helps to stabilize the fuse at the fuse element, which is the weakest portion of conductive portion 50a. The overall element, and thus overall fuse 10, is accordingly better able to withstand vibrations.

In an alternative embodiment, halves 14 and 16 of housing 12 are additionally adhered together, heat sealed together, ultrasonically sealed together or sealed together via a solvent bond. In a further alternative embodiment, housing 12 is over-molded as one piece around conductive portion 50a. Even when housing 12 is a single piece, the housing is fixed in some manner to conductive portion 50a, e.g., via cold stakes, hot stakes or rivet areas 18a to 18d.

Conductive portion 50a in one embodiment is made of pure copper. Alternatively, conductive portion 50a is made of a copper alloy, such as 151 alloy, 1925 alloy, 194 alloy, and 197 alloy. In one embodiment, conductive portion 50a is comprised of at least about ninety percent copper.

Conductive portion 50a includes first and second terminals 52a and 54a. Terminals 52a and 54a in FIG. 1 define mounting holes 56a and 56b, respectively. Fuse 10 in the illustrated embodiment is particularly well suited for a high current application, such as protecting an alternator of an automobile or protecting relatively high power lines leading from an automobile battery to a sub-system, which in turn has lower rated fuses. Terminals 52a and 54a can mount for example to one of the terminals of a car battery, for example.

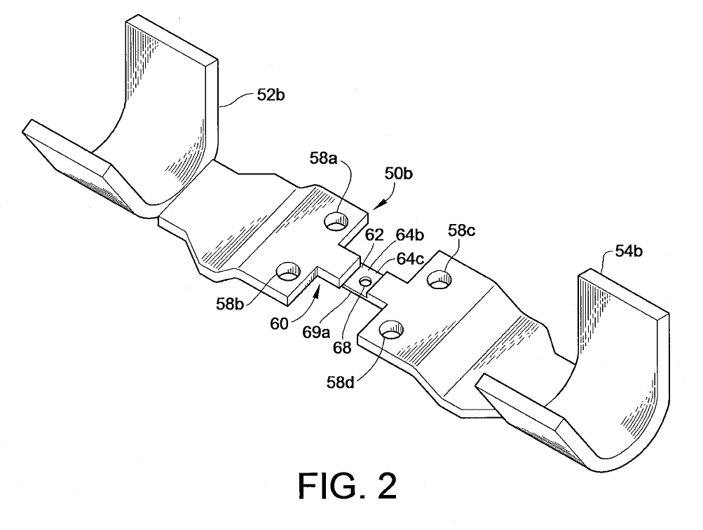

Referring now to FIG. 2, an alternative conductive portion 50b for fuse 10 is illustrated. Conductive portion 50b includes alternative terminals 52b and 54b, which are configured for crimping around a wire or cable. It should be appreciated that conductive portions 50a and 50b and the other conductive portions discussed herein are shown having a generally in line configuration. It should also be appreciated that the teachings of the present disclosure are applicable to other configurations. Conductive portion 50b is made of any of the materials listed above for conductive portion 50a.

Extensions 62a and 62b extend respectively from terminals 52b and 54b to a central fuse element 60. As illustrated, extension 62a and 62b define mounting holes 58a to 58d, which are aligned with mounting areas 18a to 18d of housing 12. In an alternative embodiment, halves 14 and 16 of housing 12 including mating male and female apparatuses that snap-fit together through apertures 58a to 58d of the conductive portion of fuse 10.

Fuse element 60 as illustrated includes a gap 62, which is formed via surfaces 64a to 64c of a base metal portion 66 of terminals 60. An aperture 68 is formed in the bottom surface 64b, which defines a portion of gap 62. Base metal 66, gap surface 64b, extensions 62a and 62b and terminals 52b and 54b in one embodiment are made of a single piece of any of the metals discussed above. Terminals extensions are formed via suitable metal bending processes. Apertures 58a to 58d and 68 in one embodiment are punched but can alternatively be laser cut or cut via a wire EDM process. Gap 62 is formed via a skiving or stamping process.

In one embodiment, conductive portion 50b (and each of the conductive portions discussed herein) is bent, punched and singulated prior to the skiving or stamping formation of gap 62. In an alternative embodiment, an elongated slot forming many gaps 62 of many conductive portions 50 (referring collectively to each of the conductive portions discussed herein) is formed before the conductive portions 50 are singulated.

As shown in more details below, gap 62 is filled, e.g., filled completely, with a low melting temperature material, such as tin or tin-alloy. The infill low temperature material operates differently than a known a Metcalf effect because the infill tin or other low melting temperature material becomes part of fuse element 60. The overall effect of the low melting temperature element 60 is to allow fuse 10 to operate more coolly and with a lower voltage drop across the fuse than if the gap was not filled with the low melting temperature material.

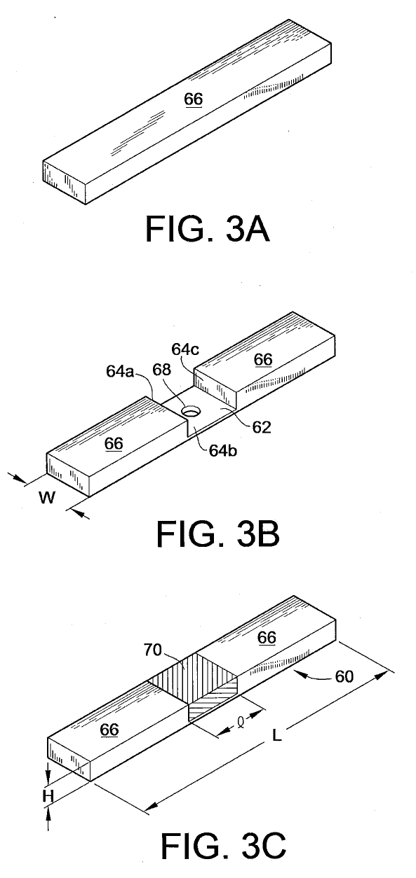

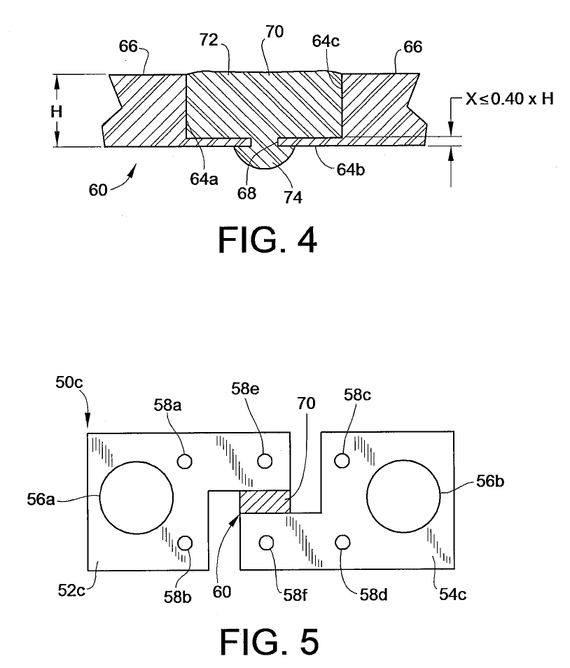

Referring now to FIGS. 3A to 3C, one sequence for forming the low operating temperature, low voltage drop fuse element 60 of the present disclosure is illustrated. FIG. 3A illustrates a stock of base metal 66, which for convenience is shown here not connected to extensions 62a and 62b. It should be appreciated however that metal portion 66 can be a unitary piece with the terminals and extensions as discussed above. FIG. 3B illustrates an intermediate step in which gap 62 is skived or stamped to produce grooved surfaces 64a, 64b and 64c. While gap 62 is shown as being generally rectangular in cross-section (see also FIG. 4), gap 62 is alternatively U-shaped or otherwise shaped to provide a desired low temperature, low voltage drop operation. After gap 62 is formed, hole 68 is drilled or punched or otherwise formed as described above. Hole 68 can be relatively small, such as about 0.040 inch in diameter. Hole 68 as seen in FIG. 3B and FIG. 4 extends all the way through the bottom surface 64b forming a portion of gap 62. Gap 62 is also shown extending through an entire width w of base metal 66.

FIG. 3C illustrates a completed low temperature, low voltage drop fuse element 60, in which low temperature melting material 70 has been filled into gap 62. Low temperature melting material 70 can be tin, tin-alloy. It may also be possible to use bismuth or bismuth-alloy. The length l of infill 70, element height H the length L of fuse element 60 and width w of fuse element 60 and infill element 70 are sized to provide desired current rating and I²R (current-resistance rating) characteristic for the resulting fuse.

Referring now to FIG. 4, a section view of fuse element 60 is illustrated. As shown, the gap 62 and resulting low temperature infill 70 consume at least about sixty percent of the height H of base material 66. That is, the thickness x of the bottom surface 64b of base metal 66 is less than or equal to about forty percent of total height H of base metal 66. In one preferred embodiment, x is less than or equal to about twenty percent of total height H of base metal 66.

FIG. 4 also illustrates that infill element 70 includes an upper portion 72 that fills gap 62 and a lower portion or bead 74 that extends through aperture 68 and onto a surface opposing bottom surface 64b of base metal 66. The bead 74 can be ground away, such that the bottom of fuse element 60 is smooth. Likewise, the top surface of upper portion 72 can be ground or otherwise smoothed. Aperture 68 is beneficial because it holds the element 70, e.g., tin, in place using the surface tension of the tin. When element 60 is under load, tin or other low melting temperature element 70 warms and becomes soft. Aperture 68 and flow-through portion 74 of element 70 help to ensure that in this state the tin infill 70 does not come free under vibration.

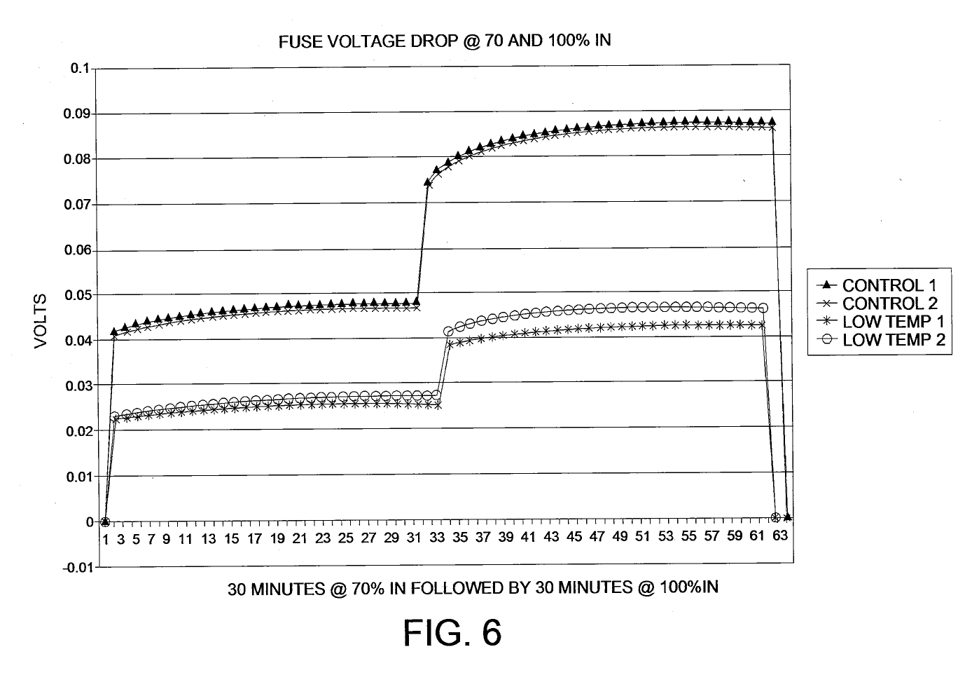

In one embodiment, tin element 70 provides an operating temperature of below about 300° C. (fuse opens at about 300° C.), which is an improvement over existing (e.g., tin dot or in spot based) fuses which open at about 550° C. Because element 60 opens at or below about 300° C., housing 12 can be a plastic housing with supports that are very close to the element, as seen in FIG. 5. Element 60 runs cooler and has a lower voltage drop (e.g., about sixty percent of a known like fuse as seen in FIG. 6), which allows the customer the option to use a less expensive plastic for the corresponding fuse box. Alternatively, the customer can increase the density of components located within a higher temperature plastic fuse box. Further, as discussed above, housing 12 can be made of a lower temperature and less expensive material. The better performing fuse element 60 also opens the possibility of increasing the thermal mass of fuse 10 to provide a higher I²t (current-time rating) value at a lower rated current than with existing fuses. In one embodiment, fuse 10 can therefore be used in a wider range of starter fuse, battery fuse and battery cable fuse applications.

Referring now to FIG. 5, metal portion 50c illustrates the structural benefits of fuse element 60 having low temperature insert 70. Metal portion 50c includes terminals 52c and 54c, each having a bolt opening 56a and 56b, respectively. Both the larger bolt openings and/or the vibration of metal portion 50c during operation place mechanical stress on the relatively weak element 60. The vibration and mounting of fuse 10 have been known to rupture or break metal portion 56c at the fuse element. In previous fuses, the element 60 runs hotter such that mounting holes 58a to 58d have to be spaced further away from the element than as illustrated in FIG. 5. The lower operating temperature of fuse element 60 of the present disclosure enables mounting holes 58e and 58f to be placed directly adjacent to fuse element 60 as shown in FIG. 5. It is expected that mounting holes 58e and 58f can be located about 0.070 inch or greater away from low temperature insert 70. Providing mounting holes this close to opening portion of element 60 at infill 70 stabilizes the relatively weak area both during the mounting of metal portion 50c and during operation of the load, which can for example be located in an automobile, which imparts a rigorous amount of vibration to fuse 10.

Referring now to FIG. 6, a pair of fuses having fuse element 60 of the present disclosure were tested for voltage drop at two different loads versus two fuses not having the low temperature infill 70. The highest two lines in the graph represent performance of Control 1 and Control 2, a set of standard MEGA® fuses provided by the assignee of the present disclosure. The lower two lines in the graph represent performance of Low Temperature 1 and Low Temperature 2, fuse elements 60 including infilled metal 70 as discussed herein. As shown, the voltage drop during thirty minutes at seventy percent of rated load current and during thirty minutes of one-hundred percent rated load current for the present fuses is about sixty percent less than that of the two control samples. FIG. 6 confirms that fuse 10 of the present disclosure has a lower voltage drop than similar fuses without element 60. The voltage drop for fuses with infill element 70 is lower due to a decreased amount of conductive material near gap 62 of fuse element 60. The low temperature material of infill element 70 (e.g., tin or other alloying element) cools the fuse and lowers its overall resistance, resulting in a lower voltage drop.

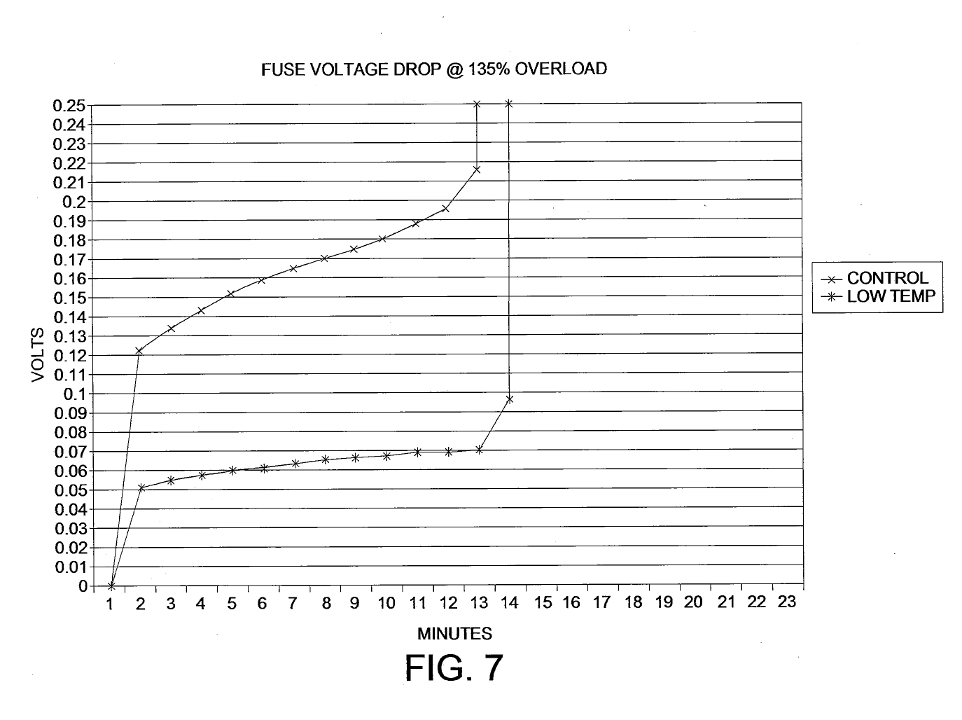

Referring now to FIG. 7, the low overload operation of fuse 10 is illustrated. The same two types of fuses in FIG. 6 are shown in FIG. 7, namely, the control or known MEGA® fuse and the low temperature fuse 10 of the present disclosure. The control fuse shown by the left, higher line shows that, when running at about one-hundred thirty-five percent of rated amperage, the fuse opens in about thirteen minutes. Fuse 10 with element 60 of the present disclosure, shown by the right and lower line, opens a short period of time after the control fuses, while providing a lower temperature, low voltage drop, as shown in FIG. 6.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A fuse comprising:
a housing; and
a conductive portion covered by the housing, the conductive portion including first and second terminals extending from a fuse element, the fuse element comprising a conductive metal and having a gap filled with a low melting temperature metal.

2. The fuse of claim 1, wherein the gap comprises a cross-section of the fuse element in which at least sixty percent of the conductive metal has been removed.

3. The fuse of claim 1, wherein the gap is completely filled with the low melting temperature metal.

4. The fuse of claim 1, wherein the base metal is one of copper and a copper alloy.

5. The fuse of claim 1, wherein the low melting temperature metal is one of tin and a tin alloy.

6. The fuse of claim 1, the housing made of a material selected from the group consisting of: nylon, polyphthalamide, phenolic and polyethylene terephthalate.

7. The fuse of claim 1, wherein the housing is fixed to the conductive portion in at least one point located directly adjacent to the fuse element.

8. The fuse of claim 1, wherein the housing is fixed to the conductive portion in at least one point located directly adjacent to the gap.

9. The fuse of claim 1, wherein the conductive metal forms a bottom surface of the gap, the gap including an aperture.

10. The fuse of claim 9, wherein the low melting temperature metal fills the aperture.

11. The fuse of claim 10, wherein the low melting temperature metal extends onto a surface of the conductive metal opposing the bottom surface of the gap.

12. A fuse comprising:
a housing; and
a conductive portion covered by the housing, the conductive portion including first and second terminals, the terminals extending from a fuse element portion of the conductive portion, the fuse element portion including an infilled low temperature metal that is configured to: (i) lower an operating temperature of the conductive portion, and (ii) lower a voltage drop across the conductive portion as compared to a fuse element portion not having the infilled low temperature metal.

13. The fuse of claim 12, wherein the fuse element portion includes a conductive metal defining a gap, the low temperature metal infilled into the gap.

14. The fuse of claim 13, wherein the gap is formed by skiving or stamping.

15. The fuse of claim 13, wherein the conductive metal forms a bottom surface of the gap, the gap including an aperture through the bottom surface, wherein the low temperature metal fills the aperture.

16. The fuse of claim 12, wherein the conductive metal is at least partially copper and the low temperature metal being at least partially tin.

17. A fuse comprising:
first and second outermost spaced terminal portions;
first and second arms extending from the respective first and second terminal portions; and
a fuse link-forming intermediate portion between the terminal portions, the fuse link-forming intermediate portion disposed between the first and second arms and comprising:
a main copper portion having a first thickness;
a notched portion disposed in the main copper portion and having a second thickness, wherein the second thickness is less than about forty percent of the first thickness; and
a tin portion disposed in the notched portion.

18. The fuse of claim 17, further comprising a housing, wherein the housing is disposed around the fuse link-forming intermediate portions, the first and second arms, and at least portions of the first and second terminal portions.

19. The fuse of claim 17, further comprising securing members disposed on the first and second arms directly adjacent the fuse link-forming intermediate portion.

20. The fuse of claim 17, wherein the fuse is configured to maintain an operating temperature of less than about 300° 0 C.
